(19) United States
(12) Patent Application Publication
(10) Pub. No.: US 2016/0214895 A1
(43) Pub. Date: Jul. 28, 2016

(54) APPARATUS AND METHOD FOR RECYCLING GYPSUM

(71) Applicant: INTERNATIONAL MATERIAL RECOVERY INC., Nanaimo (CA)

(72) Inventors: John Van Strien, Surrey (CA); William Robert Colclough, Lantzville (CA)

(21) Appl. No.: 15/005,942

(22) Filed: Jan. 25, 2016

Related U.S. Application Data
(60) Provisional application No. 62/108,459, filed on Jan. 27, 2015.

(51) Int. Cl. C04B 22/14; C04B 18/16

(52) U.S. Cl. CPC C04B 22/146; C04B 18/167

(57) ABSTRACT

A method and apparatus for recycling gypsum board which includes grinding the raw material into chunks, crushing the material further in a rolling mill which will reduce material sizes as well as partially knock gypsum off its backing paper. Material is then screened such that only gypsum material is then deposited into a hopper prior to a mixer assembly which mixes the various sizes of recycled gypsum into a consistent mixture prior to passing such material into a roll press subsystem for densifying such material to produce material of known and uniform composition suitable for cement manufacturing. Reclaimed gypsum in this specific physical form factor may then be used in significant portions as replacement for virgin gypsum in cement manufacture. The method and apparatus are applicable to the recycling of both new and renovation gypsum-based building material.

### 1. CROSS REFERENCE TO RELATED APPLICATIONS

This application is related and claims priority to U.S. Provisional Patent Application Ser. No. 62/108,459 filed Jan. 27, 2015 and entitled “Apparatus and Method for Recycling Gypsum”, which is hereby incorporated herein by reference in its entirety for all purposes.

### 2. TECHNICAL FIELD

The present invention relates generally to an apparatus and method for recycling gypsum. More specifically, the present invention relates to an apparatus and method for densifying recycled gypsum and processing into suitable form for recycled use in manufacture of cement materials.

### 3. BACKGROUND OF THE INVENTION

Gypsum is a soft sulfate mineral composed of calcium sulfate dehydrate. In the cement industry manufacturing process, virgin gypsum is added as a retarder to prevent flash setting by controlling the rate of hardening of the cement when mixed to form concrete; without it, the concrete set time can typically be unpredictable. Concrete without additives may typically dry or harden undesirably quickly for many applications, and retarding that hardening process allows workers to pour the mixture into the various forms or frames, as needed. Consequently there remains a need to provide a suitable supply of gypsum material in a suitable form factor for use in the cement manufacturing industry.

Gypsum board is primarily used as a finish for walls and ceilings, and is known in construction as drywall, sheetrock, plasterboard, wallboard, gypsum board and gypsum blocks. Throughout this patent description, the word “gypsum” will also be taken to include, but not be limited to, all these word descriptions. Additionally, “recycled” shall be defined as to treat or process (used or waste materials) so as to make suitable for reuse—it will be taken to include “used”, “old”, and “waste” materials and their recycling for reuse.

Conventional and current methods and processes focus on the potential uses for recycled gypsum back into new gypsum such as for remanufacturing new wallboard or sheetrock building materials. In other conventional applications, the use of recycled building material-based gypsum may be provided in a less desirable powdered form for other processes requiring gypsum materials. Therefore, there remains a need for methods of providing recycled gypsum material in a suitable form factor for reuse in cement and other manufacturing applications. More particularly, a need exists for an apparatus and method to provide for densification of recycled gypsum for use in cement manufacturing.

### 4. SUMMARY OF THE INVENTION

It is an object of the present invention to provide an apparatus and method for densifying recycled gypsum for use in cement manufacturing that addresses some of the limitations of the prior art.

According to an embodiment of the invention, a method of recycling gypsum is provided. In one such embodiment, the method for recycling gypsum comprises:

pre-selecting recycled gypsum material to remove defined non-usable material, the recycled gypsum material comprising gypsum and paper;

grinding the recycled gypsum material to a first size range of gypsum lumps and paper in a grinding assembly;

crushing the gypsum lumps and paper to a second smaller size range of gypsum powder to remove at least a portion of the gypsum from the paper in a roller mill assembly;

screening the gypsum powder to remove at least a portion of the paper and leave screened gypsum powder in a screening assembly;

collecting the screened gypsum powder in a hopper assembly;

admitting the screened gypsum powder in a measured flow into a mixer assembly;

mixing the screened gypsum powder with a binder additive in the mixer assembly to provide a gypsum mixture;

admitting the gypsum mixture into a roll press assembly; and

densifying the gypsum mixture into a densified gypsum form factor in the roll press assembly.

In a further embodiment of the present invention, a method of recycling gypsum is provided where the recycled gypsum material comprises drywall. In another embodiment, a method of recycling gypsum is provided where a step of pre-selecting recycled gypsum material comprises removal of at least one of plastic, wood, plaster, concrete-based and asbestos-based material.

In another embodiment, a method of recycling gypsum is provided which additionally comprises utilizing the densified gypsum form factor in manufacturing cement or other gypsum-containing products.

In yet another embodiment, an apparatus for densifying recycled gypsum is provided. In a particular such embodiment, the apparatus for densifying recycled gypsum comprises:

a grinding assembly comprising at least one grinder adapted for grinding recycled gypsum material, said recycled gypsum material comprising gypsum and paper;

a roller mill assembly comprising at least one crushing roll adapted for receiving said recycled gypsum material from said grinding assembly and for crushing said recycled gypsum material to a gypsum powder;

a screening assembly comprising a rotating drum comprising at least one screen adapted for receiving said gypsum powder from said roller mill assembly and for screening said gypsum powder to separate at least a portion of said paper from said gypsum powder;

a hopper assembly comprising at least one collection hopper adapted for receiving said gypsum powder from said screening assembly and for controlling a flow of said gypsum powder;

a mixing assembly comprising at least one mixer adapted for receiving said gypsum powder from said hopper assembly and for mixing said gypsum powder; and

a roll press assembly comprising at least one press roll adapted for receiving said gypsum powder from said mixing assembly and for densifying said gypsum powder by compression by said at least one press roll.

In another embodiment, an apparatus for densifying recycled gypsum is provided which additionally comprises at least one of:

a hammer mill assembly comprising at least one mechanical hammer and adapted to receive said gypsum powder from said screening assembly, to crush said gypsum powder, and to provide said gypsum powder to the hopper assembly; and

a secondary roller mill assembly comprising counter-rotating rollers and adapted to receive said gypsum powder from said screening assembly, to crush said gypsum powder, and to provide said gypsum powder to the hopper assembly.

In a further particular embodiment, an apparatus for densifying recycled gypsum is provided in which the roll press assembly comprises counter-rotating press rolls, and wherein a surface of each of the counter-rotating press rolls comprises at least one of pockets, depressions or voids, wherein the press rolls are adapted so as to form at least one of densified gypsum lumps, briquettes, bricks and pucks when gypsum powder passes between the counter-rotating press rolls.

Further advantages of the invention will become apparent when considering the drawings in conjunction with the detailed description.

### 5. BRIEF DESCRIPTION OF THE DRAWINGS

The system and method of the present invention will now be described with reference to the accompanying drawing figures, in which:

FIG. 1 illustrates a schematic diagram of the overall apparatus and process according to an embodiment of the present invention.

FIG. 2 illustrates a Grinder Assembly for grinding the raw material into smaller pieces, according to an embodiment of the invention.

FIG. 3 illustrates a Roller Mill Assembly for crushing the material into smaller pieces, according to an embodiment of the invention.

FIG. 4 illustrates a Screen Assembly for separating out gypsum from paper, according to an embodiment of the invention.

FIG. 5 illustrates a Gypsum Material Hopper for collecting recycled gypsum material in readiness for mixing and densification processing, according to a further embodiment of the invention.

FIG. 6 illustrates a Ribbon Mixer Assembly for ensuring that the gypsum mixture of heavy and light particles is blended together evenly, according to an embodiment of the present invention.

FIG. 7 illustrates a Roll Press Assembly for the manufacture of the recycled densified gypsum output, according to a further embodiment of the invention.

FIG. 8 illustrates an Optional Screen Assembly, according to a further embodiment of the invention.

FIG. 9 illustrates an Optional Hammer Mill Assembly, according to an embodiment of the invention.

FIG. 10 illustrates an Optional Roller Mill Assembly, according to an embodiment of the invention.

Like reference numerals refer to corresponding parts throughout the several views of the drawings.

### 6. DETAILED DESCRIPTION OF THE INVENTION

According to one embodiment, the present invention allows for the use of non-powdered, densified recycled gypsum in cement manufacturing. Powdered gypsum does not typically flow or move easily in industrial processing as it tends to stick or clump especially when left standing. Mixing powdered gypsum with virgin gypsum rock typically results in undesirably variable composition and flow. Thus, the composition of gypsum additives in cement using powdered gypsum is difficult to estimate and control. According to one aspect of the present invention, a method is provided which desirably enables a more accurate measurement of densified gypsum composition and chemistry, which desirably results in higher confidence and thus a higher inclusion rate of the densified recycled gypsum product in cement manufacturing.

According to another embodiment, a method according to the present invention is applicable to the recycling of both new gypsum (as used in new construction, e.g.) and old gypsum materials such as resulting from renovation or demolition construction sources. In one aspect, the present invention may be applicable to all types of recycled gypsum building material.

According to a further embodiment, a method and apparatus according to the present invention provides for a reduction, or desirably even elimination of clogging issues which may typically arise with handling and using gypsum powder during cement manufacturing operation.

According to one embodiment, the present invention is suitable for all types of cement manufacturing, and desirably provides for a very high percentage of paper removal from recycled gypsum. In one such embodiment, the apparatus and method of the present invention may desirably provide for the new capability of being able to use such originally paper backed recycled gypsum type materials in cement manufacturing.

In one aspect, the present invention desirably enables a variable physical form factor for densified recycled gypsum, such as but not limited to briquettes, crumbles, pellets, pucks, etc.

In a further embodiment, the present invention provides for a desirably higher inclusion rate of recycled gypsum into cement manufacture. In another aspect, the present invention may also desirably provide for a higher amount of used gypsum material to be diverted from landfills for use in new applications and markets such as in the manufacture of new building materials, such as cement.

According to one embodiment, the present invention relates to a method and apparatus for recycling gypsum incorporating forming recycled gypsum into a densified physical form factor suitable for cement manufacturing such that the percentage of virgin gypsum in such cement manufacture may be reduced and replaced by this densified recycled gypsum as produced according to embodiments of the present invention. In the present disclosure, particular dimensions quoted are exemplary in nature and are provided by way of example for illustrating a particular exemplary application only. With reference to the drawings, the invention is further described as follows:

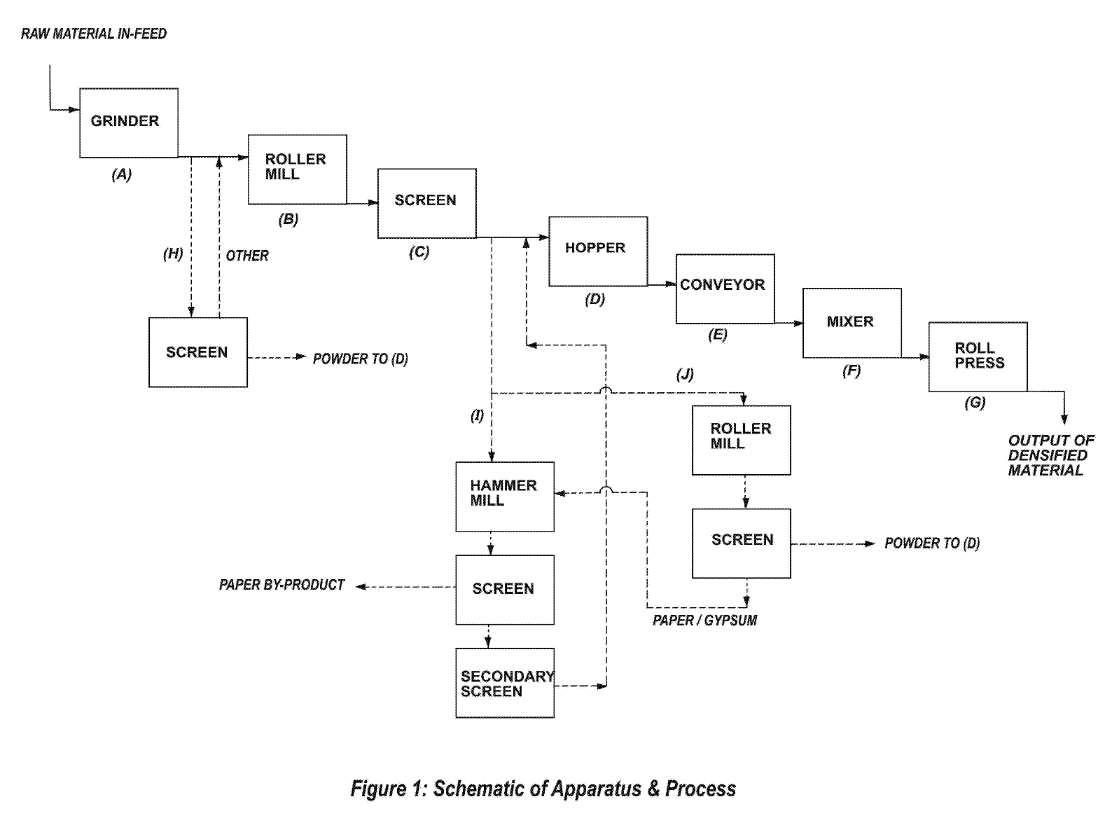

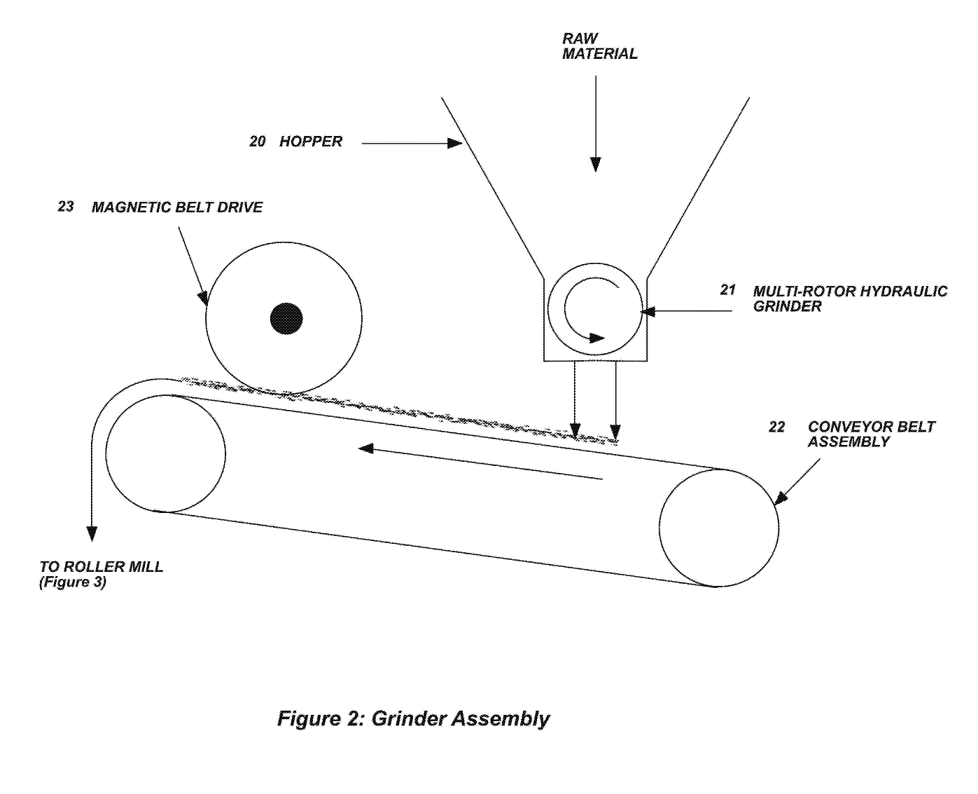

FIG. 1 illustrates a schematic diagram of an overall apparatus and method for recycling gypsum according to an embodiment of the present invention. Referring to FIG. 1, in one embodiment of the present invention, pre-selection of the raw gypsum material to be recycled may desirably be made, in order to ensure only that raw gypsum material is used that is suitable for this method and process. This step may comprise a manual sorting and removal of any non-suitable contents including asbestos-containing products, plastic, wood, plaster and concrete-based products, for example. The resulting pre-selected raw gypsum material is then fed into the Grinder Assembly A shown in FIG. 2. Sequentially following the Grinder Assembly A is a Roller Mill B, Screen Assembly C, Gypsum Material Hopper D, Conveyor E, Ribbon Mixer Assembly F, and Roll Press Assembly G. FIG. 1 further illustrates an optional Screen Assembly H situated upstream or Roller Mill Assembly B according to an optional embodiment. In a further optional embodiment, a Hammer Mill Assembly I may optionally follow Screen Assembly C, followed by one or more further supplementary screen assembly separations for further separating gypsum from backing paper material prior to the Gypsum Material Hopper D. In yet a further optional embodiment, a secondary roller mill J with optional secondary screen assembly may be optionally implemented before paper materials enter optional Hammer Mill Assembly I such as to further remove gypsum materials and provide for desirably increased performance of optional hammer mill I in such embodiments.

FIG. 2 shows an exemplary Grinder Assembly A comprising a hopper 20 into which the raw gypsum material is fed; this hopper is connected to an exemplary grinder or other suitable comminution equipment, such as a stationary hydraulic grinder 21. In one embodiment, stationary hydraulic grinder 21 may comprise a multi-rotor design which spins at high speed and reduces the large chunks of raw gypsum material into gypsum lumps (typically up to 0.75″ in size) together with paper chunks (typically up to 3″ in size) and gypsum powder. This ground gypsum and paper material then drops through onto an elevated conveyor belt 22 or other suitable material handling mover, which conveys this material under a magnetic belt 23. In one embodiment, magnetic belt 23 may be oriented at substantially right angles to the direction of the material-carrying conveyor 22. This magnetic belt 23 may typically comprise a lump of magnetic or electromagnetic material together with a fast running conveyor belt which removes any ferrous products in the ground material and typically throws them to the side away from the main material and process flow moving along conveyor 22.

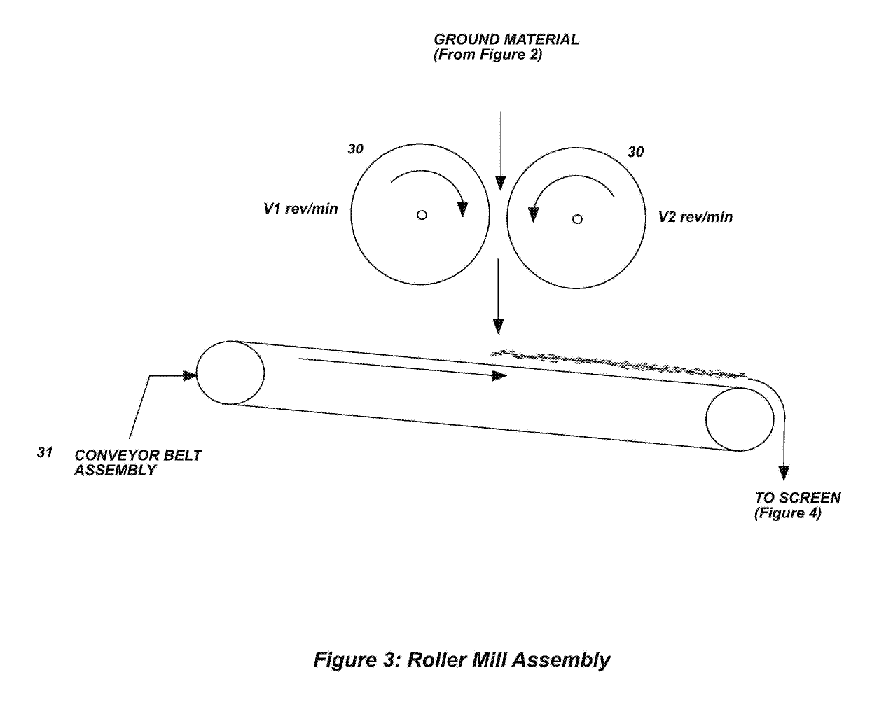

FIG. 3 shows an exemplary Roller Mill assembly B comprising two contra-rotating rollers 30, which may desirably be rotating at different rotational velocities (V1, V2). These rollers may be dynamically loaded to handle a variable input material arrival rate. Thus, material falling into the roller mill B from the grinder A will experience a crushing as well as a shearing action—the former will reduce the majority of the size of the gypsum material to smaller chunks and powder whereas the latter action will knock additional gypsum off of its paper backing. In one embodiment of the invention, both crushing and shearing actions are important for overall yield of recycled gypsum material from the raw input material. By way of example only, in one particular embodiment, roller velocities may typically be set to approximately 110 and 70 revs/min for V1, V2 respectively. Output from the roller mill B at this point in one embodiment of the invention may desirably comprise smaller gypsum material (lumps and powder) together with paper (and any attached small traces of gypsum). Material output from the roller mill B may then fall onto a conveyor belt or other suitable material handling conveyance 31.

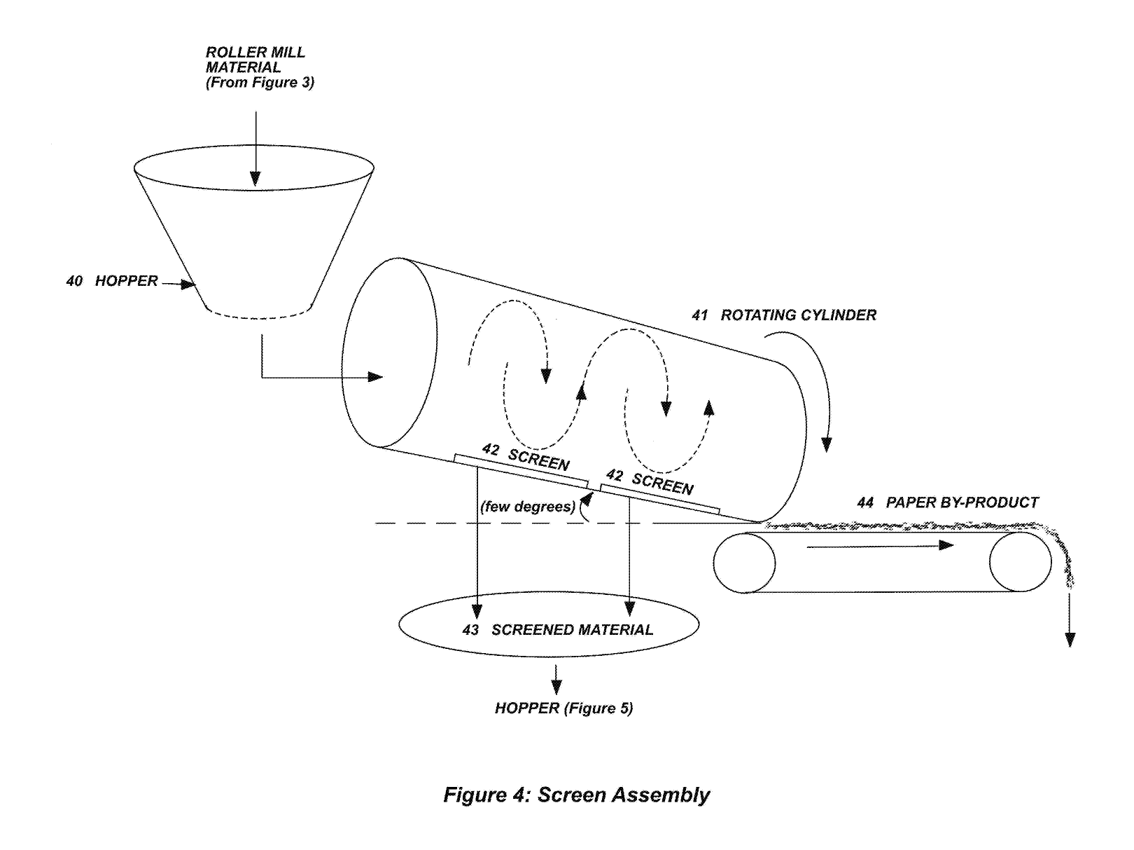

FIG. 4 shows schematically a Screen Assembly C according to one embodiment of the invention. Material from the roller mill B (shown in FIG. 3) may be input or falls into a small hopper 40 which then sends material into a rotating screen drum 41. In one exemplary embodiment, rotating screen drum 41 may comprise a 4′ diameter by 12′ long cylinder revolving at a suitable speed (typically but not limited to about 13 rpm) into which are mounted two screens (typically 4′ in length) 42 capable of passing material of a certain maximum size. The raw material now rotates and continuously tumbles within the cylinder of the rotating drum 41 as it progresses along the cylinder length. This rotating cylinder drum 41 is desirably elevated a few degrees towards the input hopper 40, to aid in material passage downward along its length. This moving and tumbling of material desirably shakes off more gypsum from the paper-backed pieces and desirably also further reduces gypsum lump size. As material progresses along the path of the cylinder 41, gypsum pieces and dust 43 will fall through the screen 42 whereas paper 44 will not and thus remains and exits at the end of the cylinder 41 onto a separate conveyor belt or other suitable material handling conveyance as paper by-product 44. Thus, material at this stage according to one embodiment may desirably now be substantially paper-free to a desired degree which is selected to be suitable for onward processing.

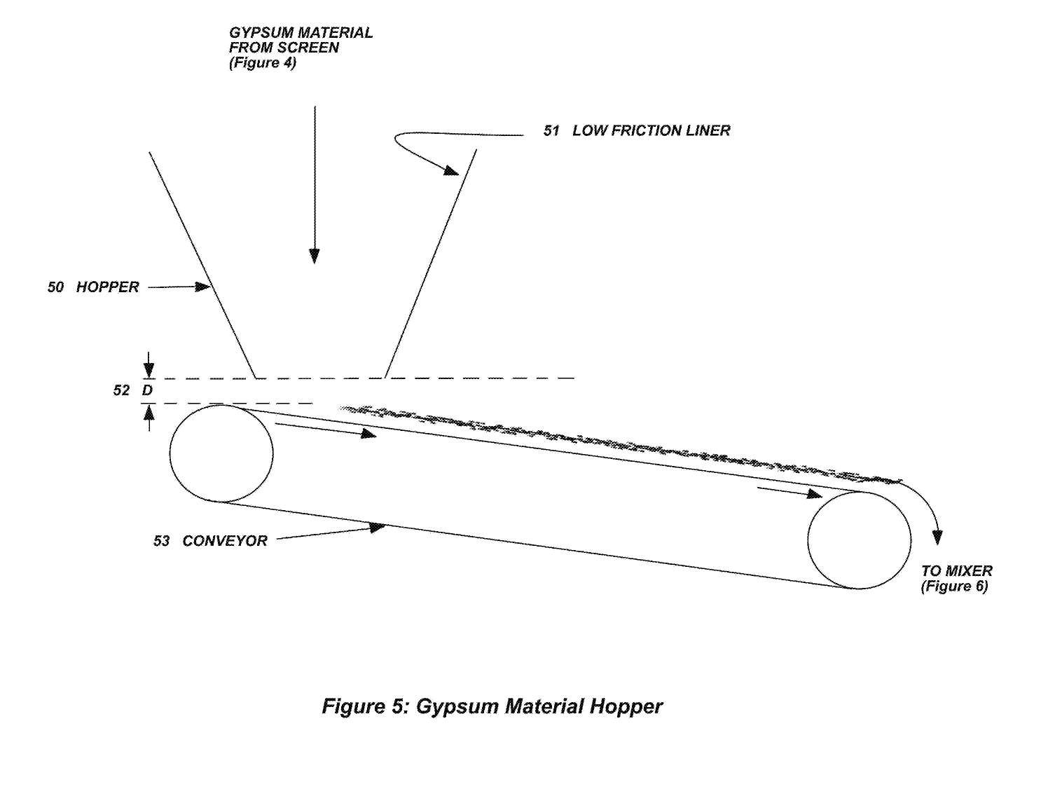

FIG. 5 depicts an exemplary Gypsum Material Hopper D, comprising input hopper 50 mounted beneath the Screen Assembly C (shown in FIG. 4). In one embodiment, input hopper 50 may be approximately 12′ long by 4′ wide and 6′ high. In order to avoid the recycled gypsum material settling and then sticking and becoming compacted on the sides of the hopper 50, a liner material 51 such as a high density polyethylene (HDPE) plastic liner 51 may be mounted on the inside of the hopper 50. In one embodiment, an HDPE or other suitable low friction and durable material may desirably enable the free flow of gypsum material through the hopper 50, such as due to its low coefficient of friction as well as narrowing the hopper discharge mouth. In a particular embodiment of the invention, the distance, 52, between the mouth of the hopper 50 and the conveyor belt 53 or other suitable material handling conveyance below desirably be carefully selected in order for there to be sufficient space such that material (gypsum powder in particular) will run freely sideways onto the conveyor belt 53 below.

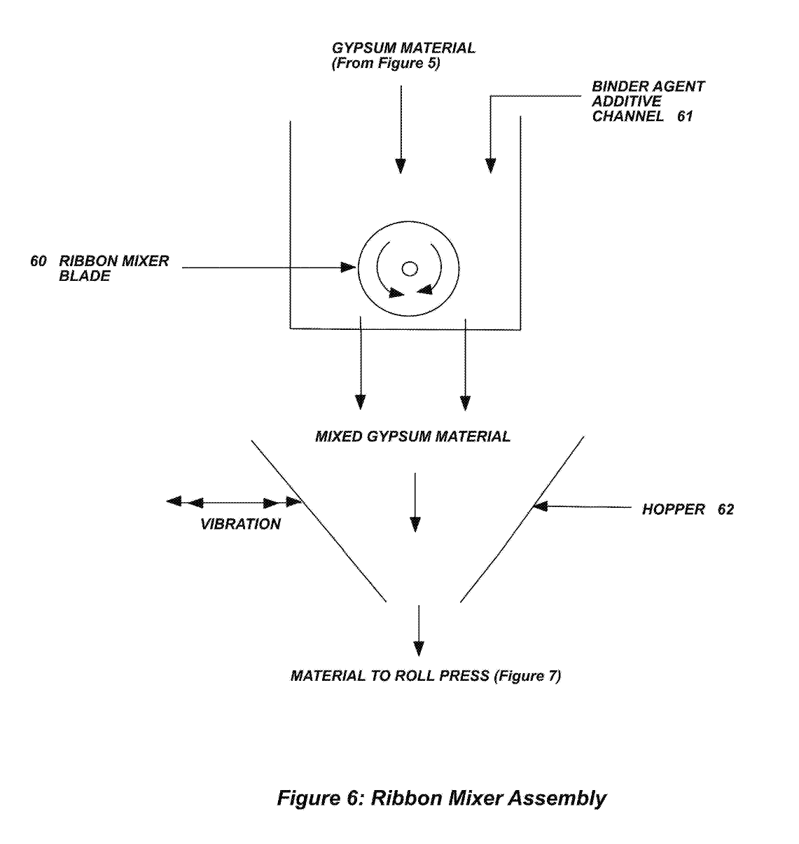

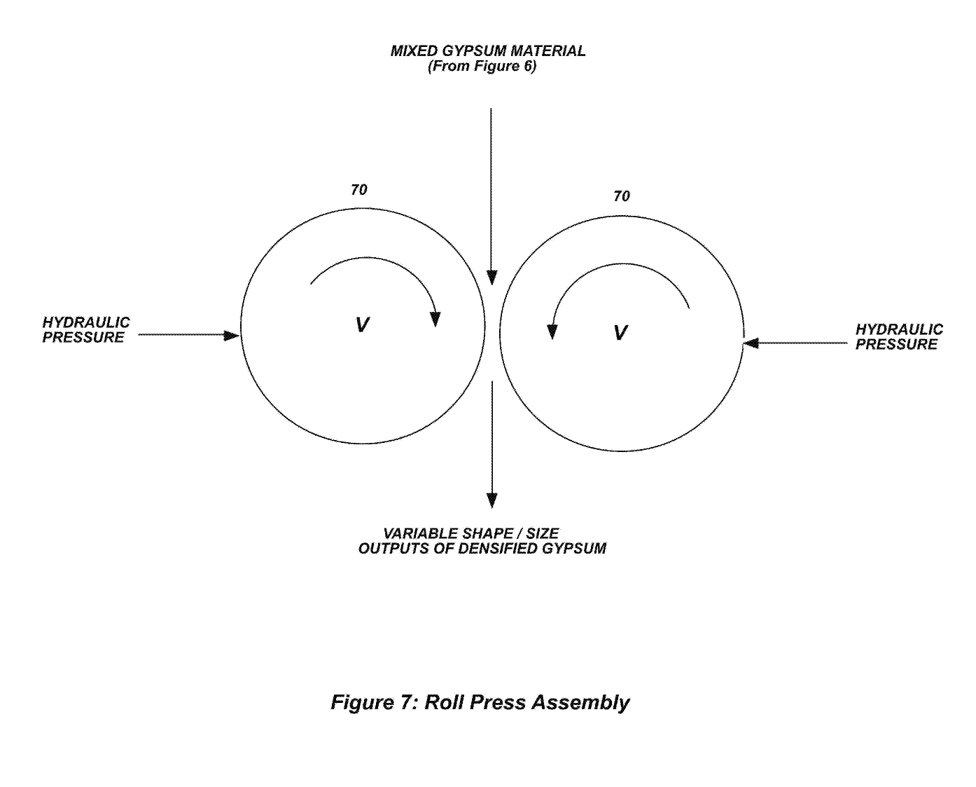

FIG. 6 illustrates a schematic view of a Ribbon Mixer Assembly F according to an embodiment of the invention. In one embodiment, the ribbon mixer assembly F may be mounted horizontally such that the gypsum material entering the ribbon mixer F from the conveyor 53 may be directed onto a ribbon mixer blade 60 at the bottom of the ribbon mixer assembly. In one such embodiment, the ribbon mixer assembly F may have dimensions of approximately 6′ long×3′ wide with an opening in the bottom. In such an embodiment, the ribbon mixer F may desirably ensure that the gypsum mixture of heavy and light particles is blended together evenly through the action of a ribbon mixer blade 60 that is designed and angled in a way that allows the gypsum mixture to move in two directions at once. The ribbon mixer F also desirably ensures that no ingredients are left undisturbed on the bottom of the mixer. In one embodiment, during mixing in the ribbon mixer F under the action of the ribbon mixer blade 60, a Binder Agent 61 may be injected into the mixture in order to bind the material together and to ensure consistency of the gypsum material and its specification as needed in cement manufacture or manufacture of other gypsum-containing products. In one embodiment, this mixing function may desirably ensure that the gypsum material output from the ribbon mixer F to the Roll Press Assembly G (illustrated in FIGS. 1 and 7) is sufficiently uniform and consistent in composition. Mounted beneath the ribbon mixer is a small hopper 62 to receive the gypsum mixture from the mixer. In one embodiment, the hopper 62 may desirably be spring mounted and may desirably vibrate at a suitable vibratory frequency in order to vibrate and move the gypsum material downward through the hopper such as for providing as input material to the Roll Press Assembly G downstream. In a particular embodiment, hopper 62 may comprise a volume of approximately 2 cubic feet.

FIG. 7 illustrates a schematic view of a Roll Press Assembly G according to an embodiment of the present invention. In one such embodiment, roll press assembly G may comprise a hydraulic roll press where the gypsum material is now densified by compression between two main counter-rotating rolls 70. In a particular embodiment, the surfaces of the main counter-rotating rolls 70 may desirably comprise pockets or other suitably sized and shaped depressions or voids so as to form densified gypsum in a variable form factor (size and shape) when the gypsum material passes between the rolls 70 under pressure. In one such embodiment, the rolls 70 may be adapted to provide for one or more of variable sized and shaped nuggets, lumps or briquettes of densified gypsum material, for example. The spacing between the rolls 70, and the hydraulic pressure between the rolls may also desirably be adjustable such as to allow for variation of the rolls 70 to accommodate variations in gypsum material or desired densified product or briquettes. The apparatus within the Roll Press assembly G may also include a variable speed motor for controllable output of densified gypsum such as may be suitable for cement manufacture or manufacture of other gypsum-containing products, for example. In one embodiment of the invention, a method for providing densified gypsum products may desirably be adjusted to provide desired form factor, quality, size and consistency of the densified gypsum product, which may be dependent on a number of factors, including but not limited to: input material arrival rate, input material particle size and composition, temperature, moisture, spacing between the rolls 70 and hydraulic pressure on the rolls 70.

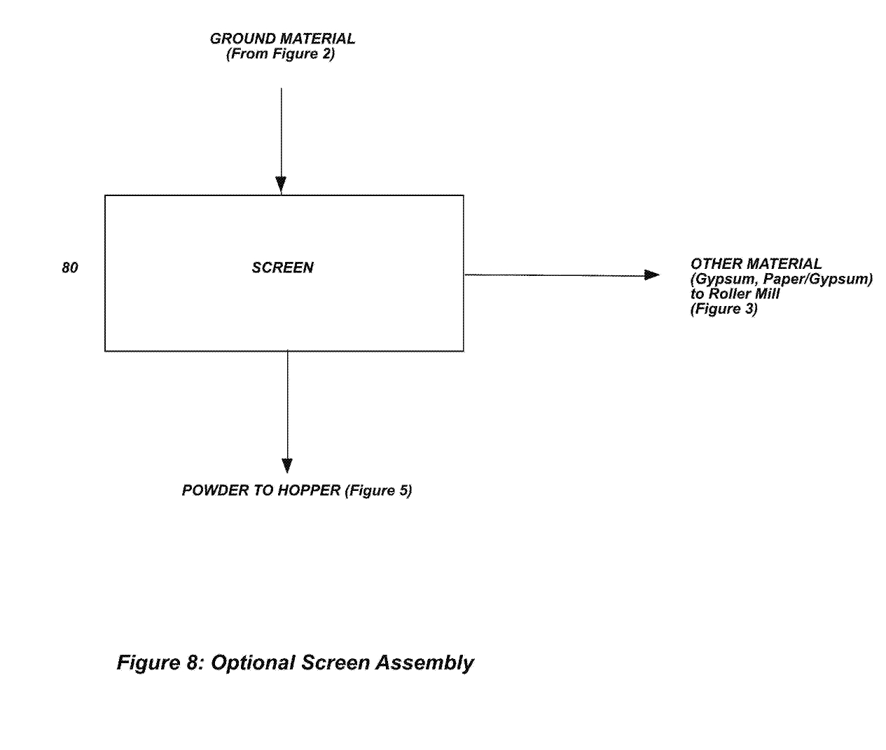

FIG. 8 illustrates an Optional Screen Assembly H, according to a further optional embodiment of the invention. In one such embodiment, screen assembly H may comprise a separation screen 80 which is adapted to separate powder sized gypsum material from larger gypsum lumps and paper, prior to the main roller mill assembly B. In such an embodiment, gypsum powder passing through screen 80 may be conveyed (such as by a suitable conveyor belt or other suitable material handling conveyance) directly to gypsum material hopper D, while gypsum lumps and paper may be returned to primary roller mill assembly B for further size reduction and separation of gypsum materials.

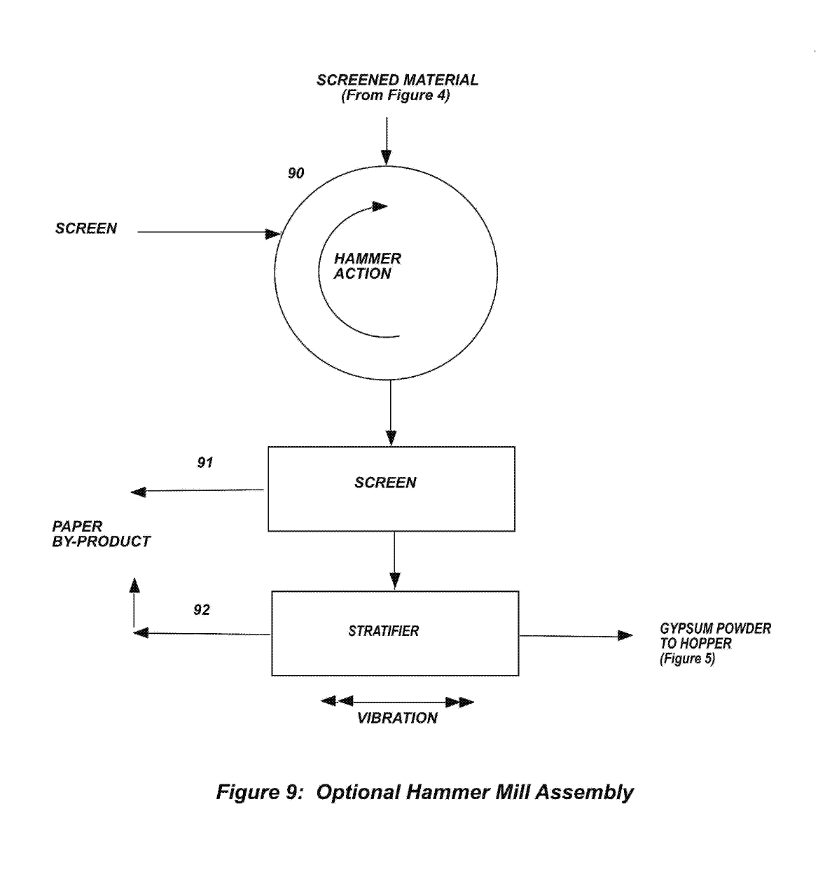

FIG. 9 illustrates an Optional Hammer Mill Assembly I, according a further optional embodiment of the invention. In one such embodiment, screened gypsum material output from the primary Screen Assembly C may optionally be directed through a hammer mill assembly I, such as to further separate gypsum material from backing paper. In one such embodiment, hammer mill assembly I may comprise a mechanical hammer mill 90 providing a mechanical hammer action to knock and reduce gypsum material from backing paper materials, followed by a separation screen 91 for separating paper materials. In one such embodiment, separation screen 91 may comprise smaller screen openings than primary Screen Assembly C, such as openings 50% smaller, for example. Following separation screen 91, gypsum materials may optionally pass through a vibrating stratifier screen 92, such as to stratify gypsum powder materials prior to return to Gypsum Material Hopper D for further processing.

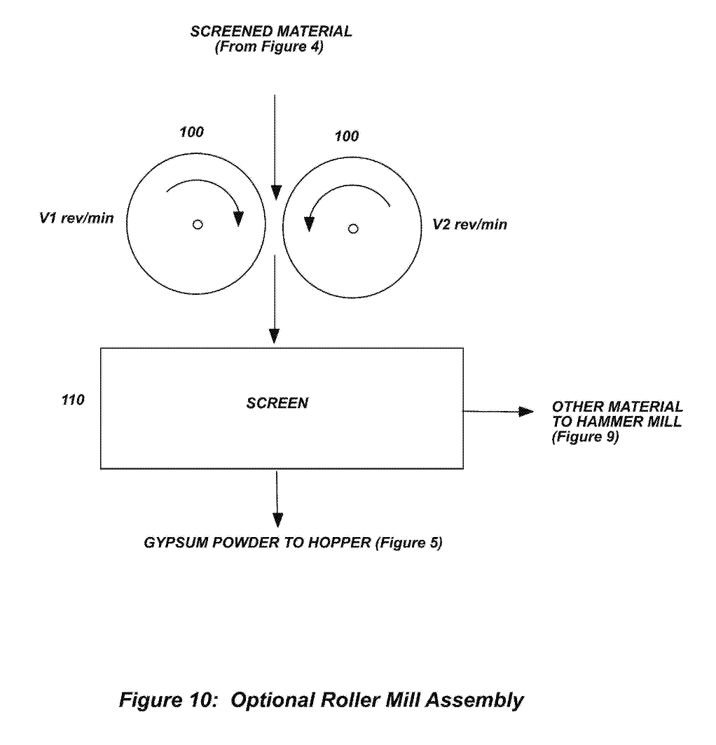

FIG. 10 illustrates an Optional Roller Mill Assembly J, according to another optional embodiment of the invention. In one such embodiment, roller mill assembly J may comprise a secondary roller mill comprising counter-rotating rollers 100, and a secondary screen assembly 110, located upstream of optional hammer mill assembly I such as to provide for increased efficiency of the optional hammer mill I in removing gypsum from paper materials, for example. In one such embodiment, rollers 100 may be dynamically loaded to handle a variable input material arrival rate. Thus, material falling into the secondary roller mill from rotating screen assembly C will experience a crushing as well as a shearing action—the former will reduce the majority of the size of the gypsum material to smaller chunks and powder whereas the latter action will knock additional gypsum off of its paper backing. Material output from the optional secondary roller mill J may then fall onto a secondary screen assembly 110 for separation of gypsum powder from larger gypsum lumps and paper, which may be passed to optional hammer mill assembly I such as by conveyor belt or other suitable material handling conveyance. Gypsum powder passing through secondary screen 110 may then be returned to gypsum hopper D for further processing according to an embodiment.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the scope thereof. Accordingly, the scope of the invention is to be construed in accordance with the substance defined by the following claims.

What is claimed is:

1. A method for recycling gypsum, the method comprising:
pre-selecting recycled gypsum material to remove defined non-usable material, said recycled gypsum material comprising gypsum and paper;
grinding the recycled gypsum material to a first size range of gypsum lumps and paper in a grinding assembly;
crushing the gypsum lumps and paper to a second smaller size range of gypsum powder to remove at least a portion of the gypsum from the paper in a roller mill assembly;
screening the gypsum powder to remove at least a portion of the paper and leave screened gypsum powder in a screening assembly;
collecting the screened gypsum powder in a hopper assembly;
admitting the screened gypsum powder in a measured flow into a mixing assembly;
mixing the screened gypsum powder with a binder additive in the mixing assembly to provide a gypsum mixture;
admitting the gypsum mixture into a roll press assembly; and
densifying the gypsum mixture into a densified gypsum form factor in the roll press assembly.

2. The method according claim 1, wherein the recycled gypsum material comprises drywall.

3. The method according claim 1, wherein the step of pre-selecting comprises removal of at least one of plastic, wood, plaster, concrete-based and asbestos-based material.

4. The method according to claim 1, wherein the grinding assembly comprises a stationary hydraulic grinder.

5. The method according to claim 1, wherein the step of grinding the recycled gypsum material additionally comprises magnetically removing ferrous material from the recycled gypsum material.

6. The method according to claim 1, wherein the roller mill comprises a plurality of counter-rotating hydraulic crushing rolls.

7. The method according to claim 6, wherein the hydraulic crushing rolls rotate at different speeds.

8. The method according to claim 1, wherein the screening assembly comprises a rotating drum comprising multiple screens.

9. The method according to claim 1, wherein the hopper assembly comprises a hopper comprising a low friction liner material on an inside surface of the hopper.

10. The method according to claim 1, wherein the mixing assembly comprises a ribbon mixer comprising a ribbon mixing blade.

11. The method according to claim 1, additionally comprising admitting the densified gypsum form factor into a cement manufacturing process.

12. The method according to claim 1, wherein screening the gypsum powder additionally comprises admitting the gypsum powder and paper to a hammer mill assembly and secondary screen.

13. The method according to claim 12, wherein screening the gypsum powder additionally comprises admitting the gypsum powder to a secondary roller mill assembly immediately preceding the hammer mill assembly.

14. The method according to claim 1, wherein the densified gypsum form factor comprises at least one of densified gypsum lumps, briquettes, bricks and pucks.

15. An apparatus for densifying recycled gypsum, comprising:
a grinding assembly comprising at least one grinder adapted for grinding recycled gypsum material, said recycled gypsum material comprising gypsum and paper;
a roller mill assembly comprising at least one crushing roll adapted for receiving said recycled gypsum material from said grinding assembly and for crushing said recycled gypsum material to a gypsum powder;
a screening assembly comprising a rotating drum comprising at least one screen adapted for receiving said gypsum powder from said roller mill assembly and for screening said gypsum powder to separate at least a portion of said paper from said gypsum powder;
a hopper assembly comprising at least one collection hopper adapted for receiving said gypsum powder from said screening assembly and for controlling a flow of said gypsum powder;
a mixing assembly comprising at least one mixer adapted for receiving said gypsum powder from said hopper assembly and for mixing said gypsum powder; and
a roll press assembly comprising at least one press roll adapted for receiving said gypsum powder from said mixing assembly and for densifying said gypsum powder by compression by said at least one press roll.

16. The apparatus for densifying recycled gypsum according to claim 15, wherein said grinding assembly comprises a stationary hydraulic grinder.

17. The apparatus for densifying recycled gypsum according to claim 15, wherein the roller mill assembly comprises a plurality of counter-rotating hydraulic crushing rolls.

18. The apparatus for densifying recycled gypsum according to claim 17, wherein the hydraulic crushing rolls rotate at different speeds.

19. The apparatus for densifying recycled gypsum according to claim 15, wherein the screening assembly comprises a rotating drum comprising a plurality of screens.

20. The apparatus for densifying recycled gypsum according to claim 15, wherein the mixing assembly comprises a ribbon mixer comprising a ribbon mixing blade.

21. The apparatus for densifying recycled gypsum according to claim 15, additionally comprising at least one of:
a hammer mill assembly comprising at least one mechanical hammer and adapted to receive said gypsum powder from said screening assembly, to crush said gypsum powder, and to provide said gypsum powder to the hopper assembly; and
a secondary roller mill assembly comprising counter-rotating rollers and adapted to receive said gypsum powder from said screening assembly, to crush said gypsum powder, and to provide said gypsum powder to the hopper assembly.

22. The apparatus for densifying recycled gypsum according to claim 15, wherein said roll press assembly comprises counter-rotating press rolls, wherein a surface of each of said counter-rotating press rolls comprises at least one of pockets, depressions or voids, wherein said press rolls are adapted so as to form at least one of densified gypsum lumps, briquettes, bricks and pucks when said gypsum powder passes between said counter-rotating press rolls.
